(19) United States
(12) Patent Application Publication
(10) Pub. No.: US 2025/0020504 A1
(43) Pub. Date: Jan. 16, 2025

(54) PRINTER AND PRINTING METHOD THEREFOR

(71) Applicant: Mettler-Toledo (Changzhou) Measurement Technology Co. Ltd., Changzhou (CN)

(72) Inventors: Yongkan Ge, Changzhou (CN); Yang Pan, Changzhou (CN)

(21) Appl. No.: 18/722,214

(22) PCT Filed: Dec. 5, 2022
(86) PCT No.: PCT/CN2022/136430

§ 371 Date: Jun. 20, 2024

(30) Foreign Application Priority Data
Dec. 3, 2021 (CN) 202111465347.X

(51) Int. Cl. G01G 23/42; G06F 3/12

(52) U.S. Cl. CPC G01G 23/42; G06F 3/1205; G06F 3/1243

(57) ABSTRACT

A printer and a printing method therefor is disclosed. The printing method includes: S1: editing a print template at a printer, the edited print template including a custom field and a variable field, and printing the custom field before the variable field; S2: obtaining weighing data at a weighing instrument; S3: obtaining weighing data that matches the variable field, inserting the matched weighing data in a position of the corresponding variable field, and printing the weighing data after the weighing data is completely matched; determining whether the weighing data at the instrument is completely sent and/or completely obtained by the printer, and if the weighing data is not completely sent and/or obtained, returning to step S2, or if the weighing data is completely sent and/or obtained, performing step S5; and S5: if there is still a custom field not printed in the print template, printing the custom field not printed.

### TECHNICAL FIELD

The present invention relates to the field of industrial weighing technologies, and in particular, to a printer and a printing method therefor.

As an example rather than a limitation, the printer and the printing method therefor provided in the present invention may be applied to the pharmaceutical industry. In the pharmaceutical industry, it is necessary in a production process to weigh raw materials in each link and print weighing data to obtain and save a related document as a record. Information to be printed as a record generally needs to include raw material name, name of a product to be produced, specifications of the product to be produced, weighing data, date and time, weighing personnel, and other information. Part of information may be directly output from a weighing instrument, while part of custom data needs to be configured and input by a user.

### BACKGROUND ART

In the field of weighing, a print template is generally configured at a weighing instrument (instrument, in the following). Information to be printed is selected at the instrument, and configured as a print template to be printed and saved at the instrument. When printing is required, the instrument may output the configured print template to a printer, and then the printer performs a printing operation after receiving data. The printer may print the print template configured by a user at the instrument on paper to form a record of weighing data.

When the user configures the print template at the instrument, only print fields such as gross weight, tare weight, net weight, date and time, and other general data defined in the instrument may generally be selected. If custom entries such as product name and company name are to be printed, the custom entries need to be edited and uploaded to the instrument in advance through a related tool, and then the custom entries uploaded to the instrument are selected when the print template is configured at the instrument. This method is complex in operations and cannot implement quick modification, and if the custom entries are to be modified, the above process needs to be repeated. In addition, if there is a typesetting requirement for the custom entries in the print template, print debugging needs to be performed for many times before confirmation, and consequently what you see is what you get cannot be implemented quickly.

### SUMMARY OF THE INVENTION

In view of the above problems in the prior art, the present invention proposes a printer and a printing method therefor, which can print weighing data quickly.

In the printing method of the present application, the user only needs to configure (edit) a print template to be printed in a host computer tool of the printer. In particular, the user only needs to configure or, as the case may be, confirm at least one of the following, wherein this configuration is carried out at the printer:
Data (information) that are not output by the instrument but customized by the user and that are to be printed. These data may be entered as character string on an editing interface of the printer, for example.
The weighing data to be printed. The weighing data consists of information provided, and usually determined, by the instrument.
The position of the weighing data to be printed on the printing result generated by using the configured print template.
The position of the customized data on the printing result generated using the configured print template.

This also means that there is no need that the user carries out any operation on the instrument that is related to the generation of the printing result or that the instrument needs to be equipped for such operations. At the instrument, the user only needs to make sure that the weighing information needed for an actual and/or future printing result is provided by the instrument to the printer.

According to a vivid example, the user only needs to configure a print template to be printed at the printer, for example in a host computer tool of the printer, and synchronously select at the instrument the weighing data the instrument needs to output to print a printing result, for example a label, that meets the requirements of the user. Specifically, when a print template to be printed is edited such that it comprises data, for example in a specific row, that is not output by the instrument but customized by the user, it is only necessary to enter character string data to be printed on an editing interface of the printer, for example of its host computer tool. If the weighing data is output by the instrument as a specific sequence of records, this means a specific record is at a specific position of the weighing data output by the instrument, for example in a specific row, it is only necessary to confirm the specific positions of the records in the weighing data output by the instrument, and add a corresponding variable field [variableN] to a position where printing of the record is required in the print template, where N in the variable field represents the position in the weighing data output by the instrument of the record indexed by “variable”. “N” is called record position number and “variable” is called variable identifier, in the following. After editing by enter the character string data and adding and/or positioning variable fields, the edited print template is uploaded to the printer, for example through PC host computer software. When printing is needed, the instrument may send the weighing data to the printer. After receiving the weighing data from the instrument, the printer may first confirm a quantity of variable fields in the current print template, each variable field representing a record in the data output by the instrument, and then fills the variable fields in the print template with the corresponding records in the weighing data output by the instrument or a field thereof, for example by replacing the original variable field. Finally, other information customized by the user in the print template may be printed, for example in row order.

According to an alternative of this vivid example, the weighing data is not output by the instrument as a specific sequence of records, or it is not made of such structured output. Rather, it is only confirmed that the printer is configured to search for records in the weighing data, for example by the variable field comprising or being linked to a variable identifier suitable for searching a specific record. When printing is needed, the printer may then fill the variable field comprising or being linked to the variable identifier of a specific record by this specific record or a field thereof.

The printer and the printing method therefor provided in the present invention have, for example, the following advantages.

(1) The print template is edited at the printer instead of being edited at the instrument, as it is the case in the related art, so that the print template can be edited quickly and flexibly. Therefore, the problem of existing products/technologies that it is difficult to quickly insert, edit, and modify custom fields is solved.

(2) The weighing data sent by the instrument is parsed and recognized based on the variable fields, so that the weighing data sent by the instrument can be typeset flexibly.

(3) In a print mode in which multiple sets of weighing data are to be printed, the print template may be divided into different print areas, so that the multiple sets of weighing data can be printed on a single print ticket.

(4) A printing module configured to execute a printing task may implement quick export or import of a print template to facilitate copy propagation and batch configuration.

Specifically, the present invention proposes a printing method, including:

A step of editing a print template at a printer, the print template including a custom field and a variable field, and a step of printing the custom field, in particular printing the custom field before the variable field.

Usually, the edited print template comprises at least one custom field and at least one variable field, and at least one of the at least one custom field is printed, in particular printed before printing any variable field or any information related to a variable field.

A step of obtaining weighing data from a weighing instrument (instrument, in the following).

Usually, the obtained weighing data comprises at least one record.

A record may comprise or consist of fields, for example a numeric field for a numerical value determined by the instrument, a sting field indicating the units of this numerical value and/or a string field describing the meaning of this numerical value.

A step of obtaining weighing data, in particular a record, that match with the variable field, a step of inserting the matched weighing data in a position of the corresponding variable field, and a step of printing the weighing data after the weighing data is completely matched, this means after a record is inserted in each custom field.

In other words, the method comprises a step of obtaining the records of the at least one record that match with the variable fields of the at least one variable field, a step of inserting each matching record or a field thereof in a position of the corresponding variable field on the edited print template, and a step printing each variable field in which a matching record or a field thereof was inserted if a matching record or field thereof was inserted in each of the at least one variable field.

A step of determining whether the weighing data is completely sent by the instrument, and if the weighing data is not completely sent, returning to the step of obtaining weighing data, or if the weighing data is completely sent, performing a step of printing a custom field not printed yet if there is still a custom field not printed in the print template.

Alternatively or in addition to the step of determining whether the weighing data is completely sent by the instrument, the method may comprise a step of determining whether the weighing data is completely obtained by the printer.

Weighing data is “completely sent” or “completely obtained” if all weighing data of a weighing process is sent or obtained, wherein at least one of the following may be generated during a weighing process:
Various characteristic values that form the weighing data. Gross weight, tare weight, net weight, but also date and time, are examples of various characteristic values. The various characteristic may correspond then to the above-mentioned records of the obtained weighing data.
A plurality of weighing data, wherein each weighing data comprises at least one characteristic value (record).
   In embodiments in which a plurality of weighing data is generated, a plurality of sets of weighing data may be generated and obtained. Each set of weighing data comprises than at least one record (characteristic value), wherein the record(s) are usually the same in the sets of weighing data of the plurality of weighing data.
   In embodiments in which a plurality of weighing data is generated, each set of weighing data may correspond to a different weighing event. A weighing event may differ from another weighing event in the item measured, wherein the measured items may be of the same kind, e.g. the same component, raw material or a specific ingredient, and/or in the measurement time. For example, sets of weighing data may be generated at predefined points in time, for example after predefined time intervals.

Therefore, in other words, the method comprises a step of determining whether all weighing data is obtained from the weighing instrument, and if all weighing data is not obtained, returning to the step of obtaining weighing data, or if all weighing data is obtained, performing the step of printing a custom field not printed yet.

The not yet printed custom field, if there is a not yet printed custom field in the edited print template, is usually a custom field of the at least one custom field. In other words, the step of printing a custom field not printed yet may be or comprise a step of printing the custom fields of the at least one custom field not printed yet if there is still a custom field not printed in the print edited template.

According to an embodiment of the present invention, the print template edited in the step of editing a print template, this means the edited print template, includes at least two print areas, for example two or three print areas, wherein at least one of the print areas, for example one of the print areas, includes only a plurality of variable fields arranged in rows, and at least one other print area, for example the other print areas, include a plurality of custom fields arranged in rows.

According to an embodiment of the present invention, the step of editing a print template includes entering content for the custom field, more precisely for a custom field of the at least one custom field, and typesetting the custom field.

The step of obtaining weighing data that match with the variable field, this means the step of obtaining the records of the at least one record that match with the variable fields of the at least one variable fields, may be implemented in a number of ways. For example, at least one of the following may apply in embodiments:
The position of matching weighing data is known or determined, wherein the variable field comprises a variable identifier and a position number, wherein in the step of obtaining weighing data that match with the variable field, matched weighing data is obtained using the position number.
The position of the matching weighing data, in particular of a record, may be known from a step of making sure, at the instrument, that the weighing data, in particular records, needed for generating an envisaged printing result is provided by the instrument to a printer.
The position of the matching weighing data, in particular of a record, may be determined by use of a search algorithm, in particular a search algorithm that uses the variable identifier.
For example, the weighing data may be obtained and/or stored as rows. The variable field may include then a variable identifier and a position number that is a data row number, and in the step of obtaining weighing data that match with the variable field, matched weighing data is obtained using the data row number, and each row of weighing data may be put in a position of a variable field comprising the data row number of the row of weighing data.
According to an embodiment of this exemplary embodiment, each row of weighing data may be put in the position of the variable field comprising the data row number of the row of weighing data, in particular to replace the variable field.
In other words and independent whether the before mentioned exemplary embodiment comprising weighing data obtained and/or stored as rows is implement, for each record corresponding to a variable field of the at least one variable field, the position of the record in the weighing data may be known or determined, wherein each variable field of the at least one variable field may comprise a record position number that represents the position of the corresponding record in the weighing data, and wherein in the step of obtaining the records of the at least one record that match with the variable fields of the at least one variable field, a matching record may be obtained using the record position number.
If the above-mentioned exemplary embodiment comprising weighing data obtained and/or stored as rows is implement, the weighing data obtained in the step of obtaining weighing data are obtained as rows of records and/or the method comprises a step of storing the weighing data obtained in the step of obtaining weighing data as rows of records, wherein the record position number is a record row number indicating a row of the rows of records, and wherein the step of inserting comprises inserting each row of record or a field thereof in the position of the variable field comprising the corresponding record row number.
Independent of the concrete realization of step of obtaining weighing data that match with the variable field, the step of inserting may comprise inserting each matching record or a field thereof in the position of the variable field comprising the record position number of the matching record.
The step of obtaining the records of the at least record that match with the variable fields of the at least one variable field comprises a substep of analyzing the obtained weighing data for a record that matches with a variable field of the at least one variable field.
For example, each variable field of the at least one variable field may comprise a variable identifier, wherein the substep of analyzing may comprise using the variable identifier in searching the obtained weighing data for a record that matches with a variable field of the at least one variable field.
In particular, a searching algorithm may be used, wherein the searching algorithm is configured to use the variable identifier for finding a record of the obtained weighing data that matches with a variable field of the at least one variable field.
The variable identifier may be, and usually is, the same as the one disclosed above.
A found record that matches with a variable field of the at least one variable field may be inserted, or a field thereof may be inserted, in the edited template according to any embodiment disclosed above.

According to an embodiment of the present invention, in the step of determining whether all weighing data is sent and/or obtained, if the weighing data is not completely sent and/or obtained, all the variable fields are restored. In this case returning to the step of obtaining weighing data is required and usually initiated.

In other words, the method may comprise a step of restoring the at least one variable field according to the print template edited in the step of editing a print template if it is determined in the step of determining whether all weighing data is obtained that all weighing data is not obtained. In addition, the method may comprise a step of returning to the step of obtaining weighing data.

The step of restoring and the step of returning may be implemented in the method according to any embodiment disclosed.

According to an embodiment of the present invention, if the weighing data is completely sent, the printer performs the step of printing a custom field not printed yet upon receiving a sending completion signal.

This also means that the printer may receive a sending completion signal if all weighing data is sent by the instrument.

Alternatively or in addition, according to an embodiment of the present invention, the step of determining whether the weighing data at the instrument is completely sent and/or obtained may include determining whether the printer receives an external instruction or setting a delay waiting time at the printer.

The present invention further provides a printer configured to carry out the printing method according to any embodiment disclosed. In particular, the printer comprises:
An editing module configured to edit a print template.
In particular, the editing module may be configured to generate an edited print template according to any embodiment disclosed with respect to the printing method.
The edited print template may be, and usually is, stored on the printer, for example a host computer tool thereof. In other words, the printer comprises the edited print template.
The edited print template may be according to any embodiment disclosed with respect to the printing method.
In particular, the edited print template comprises a, in particular at least one, custom field and a, in particular at least one, variable field.
A storage module configured to obtain weighing data from a weighing instrument.
The weighing data may be obtained and, as the case may be, stored according to any embodiment disclosed with respect to the weighing instrument.
A data matching module configured to obtain weighing data, in particular a record, that match with the variable field and to send an instruction to the editing module such that the editing module inserts the matched weighing data in a position of the corresponding variable field.
In particular, the data matching module may be configured to obtain matched weighing data according to any embodiment of the step of obtaining weighing data that match with a variable field.
In particular, the data matching module may be configured to obtain the records of the at least one record that match with the variable fields of the at least one variable field and to send an instruction to the editing module such that the editing module inserts each matching record or a field thereof in a position of the variable field on the edited print template.
A determining module configured to determine whether the weighing data at the instrument is completely obtained and/or sent
Further, the determining module may be configured to generate a print instruction if the weighing data is completely obtained and/or sent.
The determining module may be configured to determine whether the weighing data at the instrument is completely obtained and/or sent according to any embodiment of the corresponding step disclosed with respect to the printing method.
In particular, the determining module may be configured to determine whether all weighing data is obtained, and if all weighing data is obtained, generate a print instruction.
A printing module configured to execute a printing task, in particular to print data according to the edited print template.

As disclosed with respect to the printing method, according to an embodiment of the present invention, the variable field includes a variable identifier and a position number, for example a data row number. Then, the data matching module may obtain matched weighing data using the position number, and the editing module may replace, with each record of the weighing data or a field thereof, a variable field corresponding to a position number of this record.

In particular, the data matching module may be configured to carry out this obtaining of matched weighing data and the editing module may be configured to carry out this replacement.

According to the printer and the printing method therefor in the present invention, the print template is edited at the printer, so that weighing data can be printed quickly.

It should be understood that the above general description and the following detailed description of the present invention are both exemplary and illustrative, and are intended to provide further explanations for the present invention.

### BRIEF DESCRIPTION OF THE DRAWINGS

The accompanying drawings are included to provide a further understanding of the present invention and are incorporated in and constitute a part of the present application, show the embodiments of the present invention, and serve to, together with the description, explain the principles of the present invention. In the accompanying drawings:

FIG. 1 is a flowchart of a printing method according to an embodiment of the present invention;

FIG. 2 is a schematic representation of all weighing data sent by a weighing instrument during an exemplary embodiment of the method;

FIG. 3a is a schematic representation of an edited print template generated during an exemplary embodiment of the method;

FIG. 3b is a schematic representation of a printing result generated from the edited print template according to FIG. 3a and the weighing data according to FIG. 2;

FIG. 4 is a schematic representation of all weighing data sent by a weighing instrument during another exemplary embodiment of the method;

FIG. 5a is a schematic representation of another edited print template generated during an exemplary embodiment of the method;

FIG. 5b is a schematic representation of a printing result generated from the edited print template according to FIG. 5a and the weighing data according to FIG. 4;

FIG. 6 is a schematic structural diagram of a printer according to an embodiment of the present invention; and

FIG. 7 is a more detailed flowchart of an embodiment according to FIG. 1.

### DETAILED DESCRIPTION OF EMBODIMENTS

It should be noted that, in the case of no conflict, the embodiments and the features thereof in the present application can be combined with each other.

The technical solutions in the embodiments of the present application will be clearly and completely described below in conjunction with the drawings. Apparently, the described embodiments are merely some rather than all of the embodiments of the present application. The following description of at least one exemplary embodiment is merely illustrative, and in no way serves as any limitation on the present application and application or use thereof. All other embodiments derived by those of ordinary skill in the art based on the embodiments of the present application without creative efforts fall within the protection scope of the present application.

It should be noted that the terms used herein are merely for describing specific implementations, and are not intended to limit the exemplary implementations according to the present application. As used herein, unless the context clearly indicates otherwise, the singular forms are intended to include the plural forms as well. Moreover, it should also be understood that when the terms “include(s)” and/or “comprise(s)” are used in the description, it indicates the presence of features, steps, operations, devices, components, and/or combinations thereof.

Unless specifically stated otherwise, the relative arrangement of components and steps, numerical expressions and numerical values set forth in these embodiments do not limit the scope of the present application. In addition, it should be understood that, for ease of description, the sizes of various parts shown in the drawings are not drawn to scale. The technologies, methods, and devices known to those of ordinary skill in the related art may not be discussed in detail, but where appropriate, the technologies, methods, and devices should be regarded as part of the authorization specification. In all examples shown and discussed here, any specific value should be interpreted as merely exemplary and not as limiting. Therefore, other examples of the exemplary embodiment may have different values. It should be noted that similar reference signs and letters refer to similar items in the following drawings. Therefore, once a specific item is defined in one of the drawings, it need not be further discussed in subsequent drawings.

In the description of the present application, it should be understood that an orientation or position relationship indicated by orientation terms such as “front, rear, upper, lower, left, and right”, “transverse, longitudinal, vertical, and horizontal”, and “top and bottom” is usually based on an orientation or position relationship shown in the drawings, which is only for the convenience of describing the present application and simplifying the description. Unless otherwise stated, these orientation terms do not indicate or imply that an apparatus or element referred to must have a specific orientation or be constructed and operated in a specific orientation, so that the orientation terms cannot be understood as a limitation of the protection scope of the present application; and the orientation terms “inner and outer” refer to the inside and outside relative to the contour of each component itself.

For convenience of description, spatially relative terms such as “on”, “above”, “on the top surface”, and “upper” can be used herein to describe a spatial position relationship between a device or a feature shown in the figure and other devices or features. It should be understood that spatially relative terms are intended to include different orientations in use or operation in addition to the orientation of the device described in the figure. For example, if the device in the figure is inverted, the device described as “on other devices or structures” or “above other devices or structures” will then be positioned as “under other devices or structures” or “below other devices or structures”. Therefore, the exemplary term “above” may include two orientations “above” and “below”. The device may also be positioned in other different manner (rotated by 90 degrees or in other orientations), and spatially relative description used here is explained accordingly.

In addition, it should be noted that the use of words such as “first” and “second” to define parts is merely for the convenience of distinguishing between corresponding parts. Unless otherwise stated, the above words have no special meaning and therefore cannot be understood as limitation of the protection scope of the present application. Furthermore, although the terms used in the present application are selected from well-known common terms, some of the terms mentioned in the specification of the present application may have been selected by the applicant according to his or her determination, and the detailed meaning thereof is described in the relevant section described herein. Furthermore, the present application must be understood, not simply by the actual terms used but also by the meaning encompassed by each term.

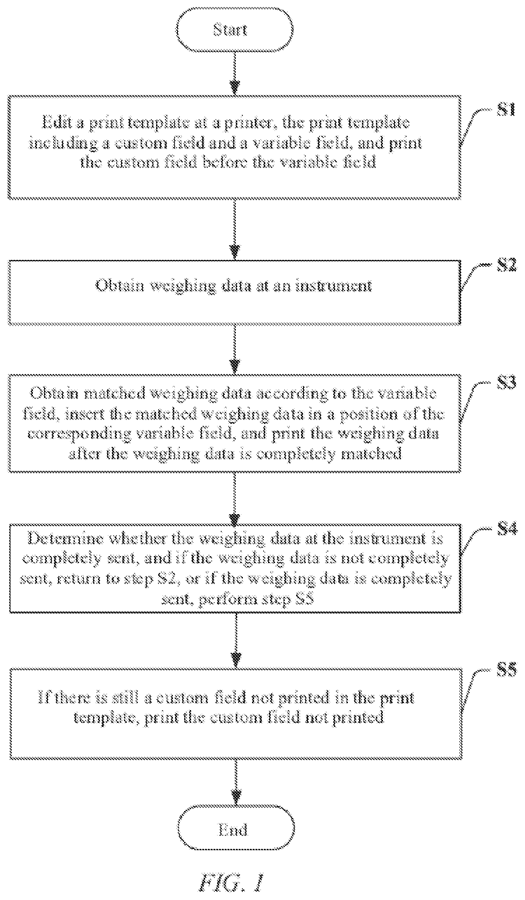

FIG. 1 is a flowchart of a printing method according to an embodiment of the present invention. As shown in the figure, the printing method includes steps as follows.

In step S1, a print template is edited at a printer, the print template 1 including a custom field 2 and a variable field 3, and the custom field before the variable field is printed. There may be a plurality of custom fields 2 and a plurality of variable fields 3.

In step S2, weighing data 4 at an instrument is obtained and send to the printer. In other words, the printer obtains weighing data from the instrument in step S2.

For example, the weighing data 4 is arranged in rows, of which each includes a custom field and a data value corresponding to the custom field. For example, the first row includes tare weight and a related data value, and the second row includes gross weight and a related data value.

In step S3, matched weighing data is obtained according to the variable field 3, the matched weighing data is inserted in a position 6 of the corresponding variable field 3, and the weighing data is printed after the weighing data is completely matched.

In step S4, whether the weighing data at the instrument is completely sent and/or whether the weighing data is completely obtained by the printer is determined, and if the weighing data is not completely sent and/or obtained, returning to step S2 is required, or if the weighing data is completely sent and/or obtained, step S5 is performed. In other words, whether a single piece of data, for example a single record 5 or a single set of weighing data 40, or a plurality of pieces of data, for example a plurality of records 5 or a plurality of sets of weighing data 4, are to be printed currently is determined, and if a single piece of data is to be printed, step S5 is performed, or if a plurality of pieces of data are to be printed, step S2 is performed to continue to obtain weighing data at the instrument.

In S5, if there is still a custom field 2 not printed in the print template 1, the custom field not printed is printed.

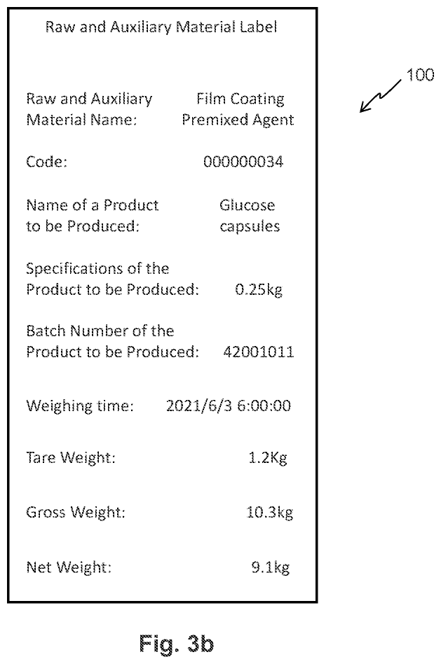

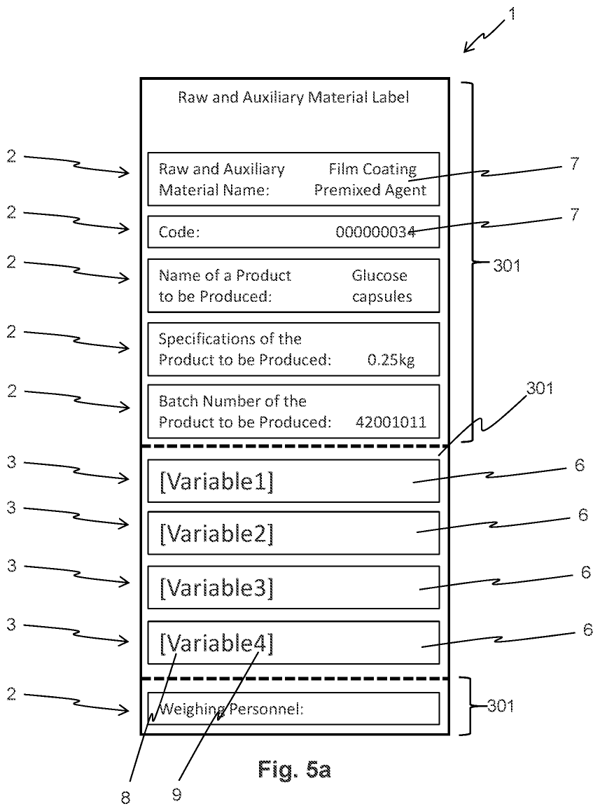

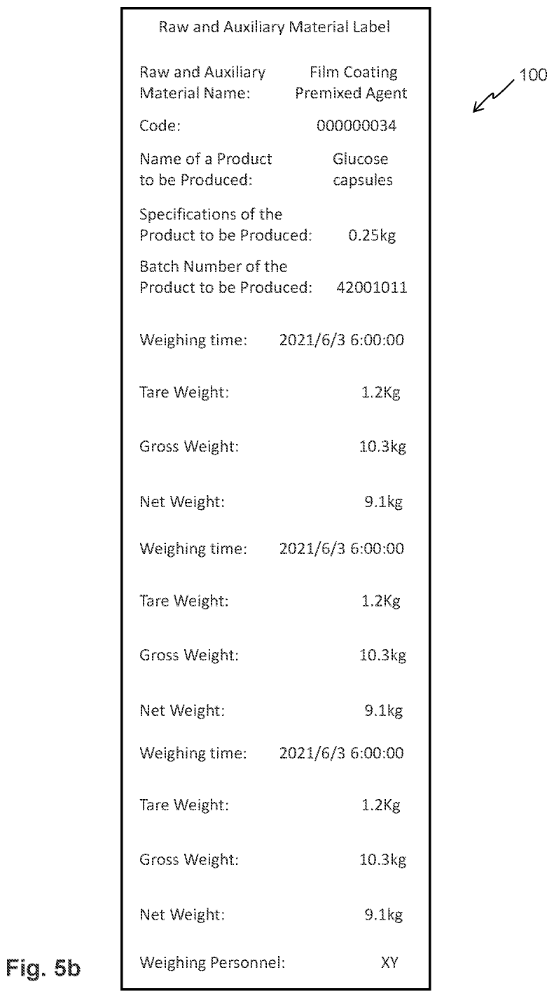

Preferably, as shown exemplarily in FIGS. 3a and 5a, the print template 1 in step S1 includes two or three print areas 201, 301, where one of the print areas includes only a plurality of variable fields 3 arranged in rows, and the other print areas include a plurality of custom fields 2 arranged in rows. Generally, there are two types of print templates: one type includes two print areas 201: a print area for custom fields 2 followed by a print area for variable fields 3; and the other type includes three print areas 301, where only the middle print area is for variable fields 3.

Preferably, as shown in FIGS. 3a and 5a, editing a print template in step S1 includes entering content 7 for the custom field 2 and typesetting the custom field 2. A user may directly enter content for the custom field in the print template, and edit the content for the custom field to comply with reading habits or highlight the importance of some of the custom fields.

In the above-mentioned exemplary embodiment comprising weighing data 4 arranged in rows, the variable field 3 may include a variable identifier 8 and a data row number 9. The data row number actually corresponds to a row number of each piece of data 5 in the weighing data 4, and may be designed to a positive integer. In step S3, matched weighing data is obtained according to the data row number 9, and each row of data in the weighing data is put in a position 6 of a variable field 3 corresponding to a data row number of the row of data to fill the print template 1. Alternatively, each row of data in the weighing data 4 is put in the position 7 of the variable field 3 corresponding to the data row number 9 of the row of data to replace the variable field.

According to an embodiment, in step S4, if the weighing data 4 is not completely sent and/or obtained, all the variable fields 3 are restored, and returning to step S2 is required. If the data 4 is not completely sent, there are multiple pieces of data to be printed, in particular multiple sets of weighing data 4. Therefore, all the original variable fields 3 in the print area are restored, and a next set of matched weighing data is about to be obtained.

If the data is completely sent and/or obtained, the printer may perform step S5 upon receiving a sending completion signal.

For example, determining whether the weighing data 4 at the instrument is completely sent and/or whether the weighing data 4 is completely obtained by the printer may include determining whether the printer receives an external instruction or setting a delay waiting time at the printer. The external instruction may be a manual operation, and after it is determined that there is no more weighing data, a sending completion signal may be generated through a keyboard input. Alternatively, the delay waiting time such as 30 seconds may be set at the printer, and if no new weighing data is received within 30 seconds, step S5 is performed.

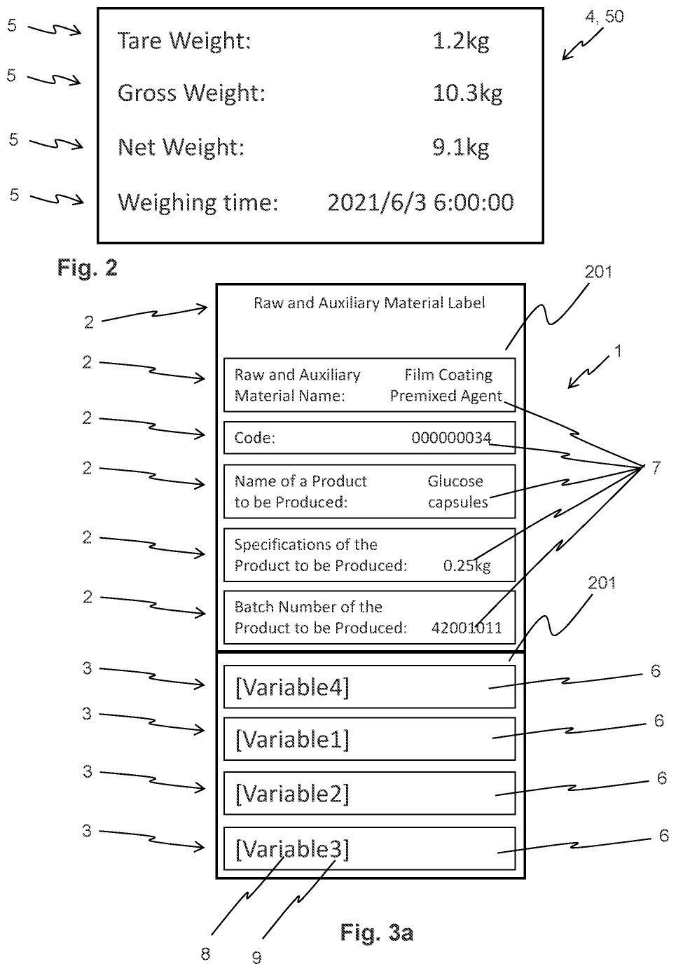

FIG. 3a is a schematic representation of an edited print template 1 including two print areas, FIG. 2 is a schematic representation of exemplary weighing data 4, and FIG. 3b is a schematic representation of a printing result 100 according to an embodiment of the present invention. The shown print template 1 includes only two print areas 201 located one above the other. From top to bottom, the first print area 201 includes six rows of custom fields 2, and the lower print area 201 includes four rows of variable fields 3. The shown weighing data includes four rows of data corresponding to a quantity of the variable fields 3. The shown print result 100 is a final print ticket. Printing is performed according to the steps of the present invention.

In S1, the print template is edited at a printer. The edited print template 1 includes six custom fields 2 in the upper part and four variable fields 3 in the lower part. After the print template is edited, the six rows of custom fields before the variable fields are all printed directly to obtain the six rows of custom fields on the print ticket 100 shown in FIG. 3b.

In S2, weighing data 4 at an instrument is obtained, including four rows 5 of weighing data.

In S3, matched weighing data is obtained according to the variable fields. The first row of variable field in the print template 1 includes a variable identifier 8 “Variable” and a data row number “4” (reference sign 9), and is matched with the fourth row of weighing data 4: “Weighing Time: 2021/6/3 6:00:00”. The matched weighing data is inserted in a position 6 of the corresponding variable field “Variable4” to directly replace it with “Weighing Time: 2021 Jun. 3 6:00:00”. Then, the second row of variable field includes a variable identifier “Variable” and a data row number “1”, and is matched with the first row of weighing data 4: “Tare Weight: 1.2 kg”. The matched weighing data is inserted in a position 6 of the corresponding variable field “Variable1” to directly replace it with “Tare Weight: 1.2 kg”. Similarly, “Variable2” is directly replaced with “Gross Weight: 10.3 kg”, and “Variable3” is directly replaced with “Net Weight: 9.1 kg”. After the weighing data is completely matched, the four rows of weighing data are printed. After the printing is completed, the print ticket 100 shown in FIG. 3b is directly obtained.

In S4, whether the weighing data 4 at the instrument is completely sent and/or whether the weighing data is completely obtained by the printer is determined. Since a single piece of data 4 is to be printed, step S5 is directly performed.

In S5, if there is no custom field 2 not printed in the print template 1, the printing task is ended.

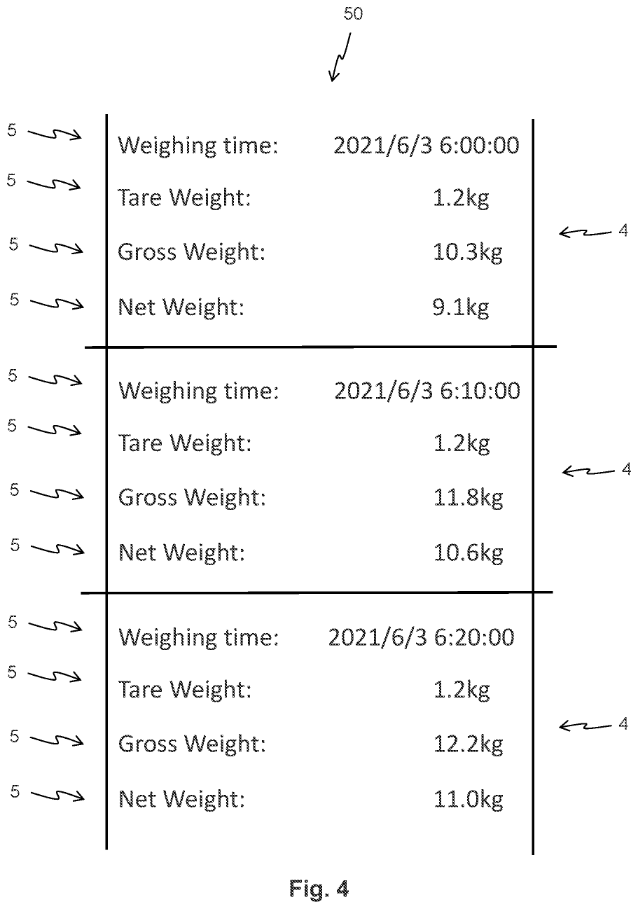

FIG. 5a is a schematic representation of a print template 1 including three print areas 301, FIG. 4 is a schematic representation of exemplary weighing data 50, and FIG. 5b is a schematic representation of a printing result 100 according to an embodiment of the present invention. The shown print template 1 includes three print areas 301 located one above another. From top to bottom, the first print area 301 includes six rows of custom fields 2, the middle print area 301 includes four rows of variable fields 3, and the lower print area 301 includes one row of custom field 2. The shown weighing data 50 includes three sets of weighing data 4, each set of weighing data includes four rows of weighing data corresponding to a quantity of variable fields 3 in the print template 1. The shown print result 100 is a final print ticket. Printing is performed according to the steps of the present invention.

S1 is performed to edit the print template at a printer. The edited print template 1 includes the six custom fields 2 in the upper part 301, the four variable fields 3 in the middle part 301, and the one custom field 2 in the lower part 301. After the print template is edited, the six rows of custom fields 2 before the variable fields are all printed directly to obtain the six rows of custom fields in the upper part of the print ticket 100 shown in FIG. 5b.

S2 is performed to obtain a first set of weighing data 4 at an instrument, the first set of weighing data including four rows 5 of weighing data.

S3 is performed to obtain matched weighing data according to the variable fields 3. The first row of variable field 3 in the print template 1 includes a variable identifier 8 “Variable” and a data row number “1” (reference sign 9), and is matched with the first row of weighing data 4, more precisely with the first row of weighing data of the first set of weighing data 4: “Weighing Time: 2021/6/3 6:00:00”. The matched weighing data is inserted in a position 6 of the corresponding variable field “Variable1” to directly replace it with “Weighing Time: 2021/6/3 6:00:00”. Then, the second row of variable field includes a variable identifier “Variable” and a data row number “2”, and is matched with the second row of weighing data 4: “Tare Weight: 1.2 kg”. The matched weighing data is inserted in a position of the corresponding variable field “Variable2” to directly replace it with “Tare Weight: 1.2 kg”. Similarly, “Variable3” is directly replaced with “Gross Weight: 10.3 kg”, and “Variable4” is directly replaced with “Net Weight: 9.1 kg”. After the weighing data, more precisely the first set of weighing data 4, is completely matched, the four rows of weighing data are printed. After the printing is completed, the corresponding four rows of weighing data are printed on the print ticket 100 shown in FIG. 5b.

Step S4 is performed to determine whether the weighing data at the instrument is completely sent and/or whether the weighing data is completely obtained by the printer. Since there are multiple pieces (sets) of weighing data 4 to be printed, all the variable fields 3 are restored, to restore the print template 1 to that shown in FIG. 5a, including the variable fields 3 but no weighing data. Returning to step S2 is required.

Step S2 continues to be performed to obtain a second set of weighing data 4 at the instrument, the second set of weighing data including four rows of weighing data.

Step S3 continues to be performed to obtain matched weighing data according to the variable fields 3. The first row of variable field in the print template 1 includes a variable identifier 8 “Variable” and a data row number “1” (reference sign 9), and is matched with the first row of the second set of weighing data 4: “Weighing Time: 2021 Jun. 3 6:10:00”. The matched weighing data is inserted in a position 6 of the corresponding variable field “Variable4” to directly replace it with “Weighing Time: 2021/6/3 6:10:00”. Then, the second row of variable field includes a variable identifier “Variable” and a data row number “2”, and is matched with the second row of the second set of weighing data: “Tare Weight: 1.2 kg”. The matched weighing data is inserted in a position 6 of the corresponding variable field “Variable2” to directly replace it with “Tare Weight: 1.2 kg”. Similarly, “Variable3” is directly replaced with “Gross Weight: 11.8 kg”, and “Variable4” is directly replaced with “Net Weight: 10.6 kg”. After the weighing data, more precisely the first set of weighing data 4, is completely matched, the four rows of weighing data are printed. After the printing is completed, the corresponding four rows of weighing data are additionally printed on the print ticket 100 shown in FIG. 5b.

Step S4 is performed to determine whether the weighing data at the instrument is completely sent and/or whether the weighing data is completely obtained by the printer. Since there is still weighing data 4 not printed, all the variable fields 3 are restored, to restore the print template 1 to that shown in FIG. 5a, including the variable fields 3 but no weighing data. Returning to step S2 is required.

Step S2 continues to be performed to obtain a third set of weighing data 4 at the instrument, the third set of weighing data including four rows of weighing data.

Step S3 continues to be performed to obtain matched data in the third set of weighing data according to the variable fields 3, which is not repeated herein. After the third set of weighing data is completely matched, the four rows of weighing data are printed. After the printing is completed, the corresponding four rows of weighing data are additionally printed on the print ticket 100 shown in FIG. 5b.

Step S4 is performed to determine whether the weighing data at the instrument is completely sent and/or whether the weighing data is completely obtained by the printer, and if the weighing data 50 is completely sent, a corresponding key on the printer is triggered to perform step S5.

Step S5 is performed to print the last custom field “Weighing Personnel:” not printed in the print template 1 to generate the print ticket 100 shown in FIG. 5b to complete the printing task for this ticket.

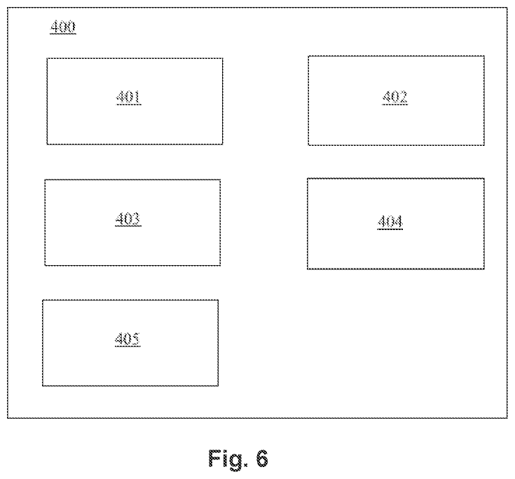

FIG. 6 is a schematic structural diagram of a printer 400 according to an embodiment of the present invention. As shown in the figure, the present invention further provides a printer 400 for performing the above printing method. The printer 400 mainly includes an editing module 401, a storage module 402, a data matching module 403, a determining module 404, and a printing module 405.

The editing module 401 is configured to edit a print template.

The storage module 402 is configured to obtain weighing data 4 at an instrument.

The data matching module 403 is configured to obtain weighing data matched with the variable field 3, and send an instruction to the editing module 401 such that the editing module 401 inserts the matched weighing data in a position 6 of the corresponding variable field 3.

The determining module 404 is configured to determine whether the weighing data 4, 50 at the instrument is completely sent and or completely obtained by the printer 400.

The printing module 405 is configured to execute a printing task in steps.

According to an embodiment—as mentioned above, the variable field 3 includes a variable identifier 8 and a data row number 9; and the data matching module 403 obtains matched weighing data according to the data row number, and the editing module 401 replaces, with each row of data in the weighing data, a variable field corresponding to a data row number of the row of data.

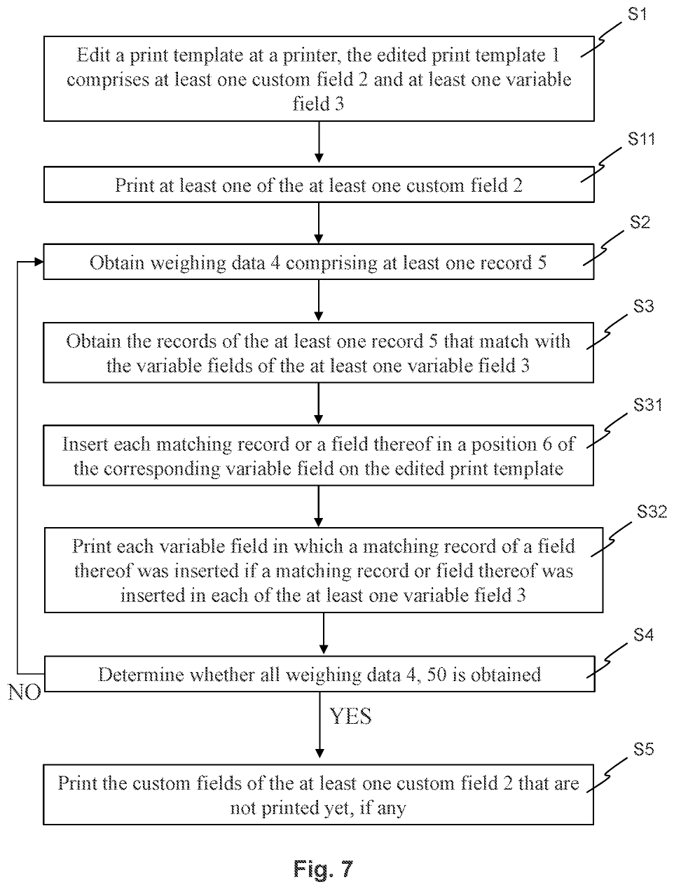

FIG. 7 is a more detailed flowchart of an embodiment of the printing method according to FIG. 1:

In the embodiment shown in FIG. 7, former step S1 is split in a step S1 of editing a print template at a printer, the edited print template 1 comprising at least one custom field 2 and at least one variable field 3, and a step S11 of printing at least one of the at least one custom field. In particular, the at least one custom field printed is printed before printing any information related to a variable field of the at least one variable field 3.

In step S2, weighing data 4 comprising at least one record 5 is obtained by the printer.

The rows of weighing data mentioned with respect to FIGS. 1-6 and the weighing data mentioned in conjunction with a matched weighing data are examples of records.

In particular, the obtained weighing data 4 may be as shown with respect to FIGS. 2 and 4, for example. However, the obtained weighing data 4 do not need to have the structure shown in FIGS. 2 and 4. In particular, the obtained weighing data 4 do not need to be in a tabular form.

The edited print template 1 may be as shown in FIGS. 3a and 5a, for example. However, in embodiments, the variable field(s) 3 does/do not comprise any position number, e.g. any record position number or data row number 9. This is in particular the case if the position of a record in the weighing data 4 is unknown and, for example, a search algorithm, in particular a search algorithm that uses a variable identifier 8, is used in the below-mentioned step S3 of obtaining matching record(s).

A record usually comprises a plurality of fields. In particular in embodiments in which a variable field 3 is filled, it may be a field of a record that is filled in.

In the embodiment shown in FIG. 7, S3 is split in a step S3 of obtaining, for example determining, the records of the at least one record 5 that match with the variable fields of the at least one variable field 3, a step S31 of inserting each matching record or a field thereof in a position 6 of the corresponding variable field 3 on the edited print template 1, and a step S32 of printing each variable field in which a matching record or a field thereof was inserted if a matching record or field thereof was inserted in each of the at least one variable field.

The step S3 of obtaining matching record(s) may be according to any embodiment of S3 disclosed with respect FIGS. 1-6. Alternatively, a search algorithm may be used, for example. The search algorithm may be run on the sequence of information that constitutes the obtained weighing data 4. The search algorithm may use search terms that are or that are derived from a variable identifier 8, in particular a variable identifier 8 as disclosed with respect to FIGS. 1-6.

The step S31 of inserting may be according to any embodiment disclosed with respect to S3 in FIGS. 1-6, although, in embodiments, inserting, in particular filling in or replacing, may base on the variable identifier 8 instead of a position number 9.

The step S32 of printing may be according to any embodiment disclosed with respect to S3 in FIGS. 1-6.

In step S4, it is determined whether all weighing data 4, 50 is obtained by the printer and if all weighing data 4, 50 is not obtained, returning to the step S2 of obtaining weighing data 4 comprising at least one record 5 is initiated, or if all weighing data 4, 50 is obtained the printing method proceeds to step S5.

The step S4 may be according to any embodiment disclosed with respect to S4 in FIGS. 1-6.

In step S5, the custom fields of the at least one custom field 2 that are not printed yet. This step may be according to any embodiment disclosed with respect to S5 in FIGS. 1-6

It can be apparent for persons skilled in the art that various modifications and variations may be made to the exemplary embodiments of the present invention without departing from the spirit and scope of the present invention. Therefore, it is intended that the present invention covers the modifications and variations of the present invention that fall within the scope of the appended claims and their equivalents.

1. A printing method, comprising:
S1: editing a print template at a printer, the edited print template comprising at least one custom field and at least one variable field;
S11: printing at least one of the at least one custom field;
S2: obtaining weighing data from a weighing instrument, wherein the weighing data comprises at least one record;
S3: obtaining the records of the at least one record that matches with the variable fields of the at least one variable field;
S31: inserting each matching record or a field thereof in a position of the corresponding variable field on the edited print template;
S32: printing each variable field in which a matching record or a field thereof was inserted if a matching record or field thereof was inserted in each of the at least one variable field;
S4: determining whether all weighing data is obtained from the weighing instrument, and if all weighing data is not obtained, returning to S2, or if all weighing data is obtained, performing S5:
printing the custom fields of the at least one custom field not printed yet if there is still a custom field not printed in the edited print template.

2. The printing method according to claim 1, wherein the edited print template comprises at least two print areas, wherein at least one of the print areas comprises only a plurality of variable fields arranged in rows, and at least one other print area comprises a plurality of custom fields arranged in rows.

3. The printing method according to claim 1, wherein the S1 comprises entering content for a custom field of the at least one custom field and typesetting the custom field.

4. The printing method according to claim 1, wherein S3 comprises a substep of analyzing the obtained weighing data for a record that matches with a variable field of the at least one variable field.

5. The printing method according to claim 4, wherein each variable field of the at least one variable field comprises a variable identifier, wherein the substep of analyzing the obtained weighing data for the record that matches with the variable field of the at least one variable field comprises using the variable identifier in searching the obtained weighing data for a record that matches with a variable field of the at least one variable field.

6. The printing method according to claim 1, wherein, for each record corresponding to a variable field of the at least one variable field, the position of the record in the weighing data is known or determined, wherein each variable field of the at least one variable field comprises a record position number that represents the position of the corresponding record in the weighing data, and wherein, in S3, a matching record is obtained using the record position number.

7. The printing method according to claim 6, wherein S31 comprises inserting each matching record or a field thereof in the position of the variable field comprising the record position number of the matching record.

8. The printing method according to claim 6, wherein the weighing data obtained in S2 are obtained as rows of records and/or wherein the method comprises a step of storing the weighing data obtained in S2 as rows of records, wherein the record position number is a record row number indicating a row of the rows of records, and wherein S31 comprises inserting each row of record or a field thereof in the position of the variable field comprising the corresponding record row number.

9. The printing method according to claim 1, wherein S31 comprises replace the variable field on the edited print template by the corresponding matching record or a field thereof.

10. The printing method according to claim 1, further comprising restoring the at least one variable field according to the print template edited in S1 if it is determined in S4 that all weighing data is not obtained.

11. The printing method according to claim 1, wherein, if all weighing data is sent by the weighing instrument, the printer receives a sending completion signal.

12. The printing method according to claim 1, wherein S4 comprises determining whether the printer receives an external instruction or setting a delay waiting time at the printer.

13. A printer, comprising:
an editing module configured to edit a print template, the edited print template comprising at least one custom field and at least one variable field;
a storage module configured to obtain weighing data from a weighing instrument, wherein the weighing data comprises at least one record;
a data matching module configured to obtain the records of the at least one record that match with the variable fields of the at least one variable field and to send an instruction to the editing module such that the editing module inserts each matching record or a field thereof in a position of the variable field on the edited print template;
a determining module configured to determine whether all weighing data is obtained, and if all weighing data is obtained, generate a print instruction; and
a printing module configured to print data according to the edited print template.

14. The printer according to claim 13, wherein each variable field of the at least one variable field comprises a variable identifier and a record position number, wherein the data matching module is configured to obtain the records of the at least one record that match with the variable fields of the at least one variable field using the record position number.

15. The printer according to claim 14, wherein the printer is configured to store the obtained weighing data as rows of records, wherein the record position number is a record row number indicating a row of the rows of records, and wherein the editing module is configured to insert each row of record or a field thereof in the position of the variable field comprising the corresponding record row number.
